(19) United States
(12) Patent Application Publication
(10) Pub. No.: US 2016/0067924 A1
(43) Pub. Date: Mar. 10, 2016

(54) FORMING APPARATUS, MANUFACTURING METHOD OF MOLDED ARTICLE, AND COATING PORTION

(71) Applicant: FUJI XEROX CO., LTD., Tokyo (JP)

(72) Inventors: Shin YASUDA, Kanagawa (JP); Haruo HARADA, Kanagawa (JP); Atsushi OGIHARA, Kanagawa (JP)

(21) Appl. No.: 14/605,447

(22) Filed: Jan. 26, 2015

(30) Foreign Application Priority Data
Sep. 9, 2014 (JP) 2014-183198

(51) Int. Cl. B29C 67/00

(52) U.S. Cl. CPC B29C 67/0085; B29C 67/0055; B33Y 10/00

(57) ABSTRACT

Provided is a forming apparatus, including a stand, and a coating portion that is relatively moved with respect to the stand while ejecting a resin to coat the stand with the resin, and forms a line in the resin according to at least one of the ejection and the movement, in order to manufacture a molded article by the resin on the stand.

### CROSS-REFERENCE TO RELATED APPLICATIONS

This application is based on and claims priority under 35 USC 119 from Japanese Patent Application No. 2014-183198 filed Sep. 9, 2014.

### BACKGROUND

### Technical Field

The present invention relates to a forming apparatus, a manufacturing method of a molded article, and a coating portion.

### SUMMARY

According to an aspect of the invention, there is provided a forming apparatus, including:

a stand; and

a coating portion that is relatively moved with respect to the stand while ejecting a resin to coat the stand with the resin, and forms a line in the resin according to at least one of the ejection and the movement, in order to manufacture a molded article by the resin on the stand.

### BRIEF DESCRIPTION OF THE DRAWINGS

Exemplary embodiments of the present invention will be described in detail based on the following figures, wherein:

FIG. 1 is a schematic view in which a state where a molded article is manufactured in a first mode by using a forming apparatus according to a first exemplary embodiment is viewed from an apparatus front surface side;

FIGS. 2A and 2B are schematic views in which a state where the molded article is manufactured by using the forming apparatus according to the first exemplary embodiment is viewed from an apparatus upper surface side, FIG. 2A is a schematic view illustrating a case where the molded article is molded in the first mode, and FIG. 2B is a schematic view illustrating a case where the molded article is molded in a second mode;

FIG. 3 is an enlarged view of a part A which is surrounded by a dotted line in FIG. 1;

FIGS. 4A and 4B are views illustrating a coating portion which constitutes the forming apparatus according to the first exemplary embodiment, FIG. 4A is a schematic view of the coating portion when viewed from an apparatus lower surface side, and FIG. 4B is a cross-sectional view along line B-B in FIG. 4A;

FIGS. 5A and 5B are views illustrating a state of a resin with which the coating portion of the forming apparatus according to the first exemplary embodiment coats a stand, FIG. 5A is a schematic view when viewed from the apparatus upper surface side, and FIG. 5B is a schematic view when viewed from an upstream side of a travelling direction of the coating portion;

FIGS. 6A and 6B are views illustrating a part of an upper surface of the manufactured molded article when the molded article is manufactured in the first mode by using a comparative apparatus, FIG. 6A is a view when viewed from the apparatus upper surface side, and FIG. 68 is a view when viewed from an apparatus width direction;

FIGS. 7A and 7B are views illustrating a part of the upper surface of the manufactured molded article when the molded article is manufactured in the first mode by using the forming apparatus according to the first exemplary embodiment, FIG. 7A is a view when viewed from the apparatus upper surface side, and FIG. 7B is a view when viewed from the apparatus width direction;

FIG. 8 is a view illustrating a part of the upper surface of the manufactured molded article when the molded article is manufactured in a second mode by using the forming apparatus according to the first exemplary embodiment, and is a view when viewed from the apparatus upper surface side;

FIGS. 9A and 98 are views illustrating the coating portion which constitutes the forming apparatus according to a first modification example of the first exemplary embodiment, FIG. 9A is a schematic view of the coating portion when viewed from the apparatus lower surface side, and FIG. 9B is a cross-sectional view along line B-B in FIG. 9A;

FIGS. 10A and 10B are views illustrating the coating portion which constitutes the forming apparatus according to a second modification example of the first exemplary embodiment, FIG. 10A is a schematic view of the coating portion when viewed from the apparatus lower surface side, and FIG. 10B is a cross-sectional view along line B-B in FIG. 10A;

FIGS. 11A and 11B are views illustrating the coating portion which constitutes the forming apparatus according to a third modification example of the first exemplary embodiment, FIG. 11A is a schematic view of the coating portion when viewed from the apparatus lower surface side, and FIG. 11B is a cross-sectional view along line B-B in FIG. 11A;

FIG. 12A is an enlarged view of a part B which is surrounded by a dotted line in FIG. 11B, and FIG. 12B is a view illustrating another aspect of FIG. 12A;

FIGS. 13A and 13B are views illustrating the coating portion which constitutes the forming apparatus according to a fourth modification example of the first exemplary embodiment, FIG. 13A is a perspective view of the coating portion, and FIG. 13B is a cross-sectional view along line B-B in FIG. 13A;

FIGS. 14A to 14C are views illustrating a state where the coating portion which constitutes the forming apparatus according to a second exemplary embodiment performs coating with the resin, FIG. 14A is a schematic view when viewed from the apparatus front surface side, FIG. 148 is a schematic view when viewed from the apparatus upper surface side, and FIG. 14C is a schematic view when viewed from the upstream side of the traveling direction of the coating portion;

FIG. 15A is a schematic view of the coating portion which constitutes the forming apparatus according to a third exemplary embodiment when viewed from the apparatus lower surface side, FIG. 153 is a schematic view of the coating portion which constitutes the forming apparatus according to a first modification example of the third exemplary embodiment when viewed from the apparatus lower surface side, and FIG. 15C is a schematic view of the coating portion which constitutes the forming apparatus according to a third modification example of the third exemplary embodiment when viewed from the lower surface side;

FIGS. 16A and 16B are views illustrating a state of the resin with which the coating portion of the forming apparatus according to the third exemplary embodiment coats a stand, FIG. 16A is a schematic view when viewed from the apparatus upper surface side, and FIG. 16B is a schematic view when viewed from the upstream side of the traveling direction of the coating portion; and

FIG. 17 is a graph illustrating strength of the resin coated by a head in Example with respect to a spatial frequency, and strength of the resin coated by a head in a comparative example with respect to a spatial frequency.

### DETAILED DESCRIPTION

Overview

Hereinafter, exemplary embodiments will be described with reference to the drawings. First, exemplary embodiments will be divided into three groups, that is, a first exemplary embodiment and modification examples thereof, a second exemplary embodiment, and a third exemplary embodiment and modification examples thereof, and will be described. Next, Example and a comparative example will be described.

### First Exemplary Embodiment and Modification Examples Thereof

First, a first exemplary embodiment and modification examples thereof will be described with reference to the drawings.

### First Exemplary Embodiment

### Function of Forming Apparatus

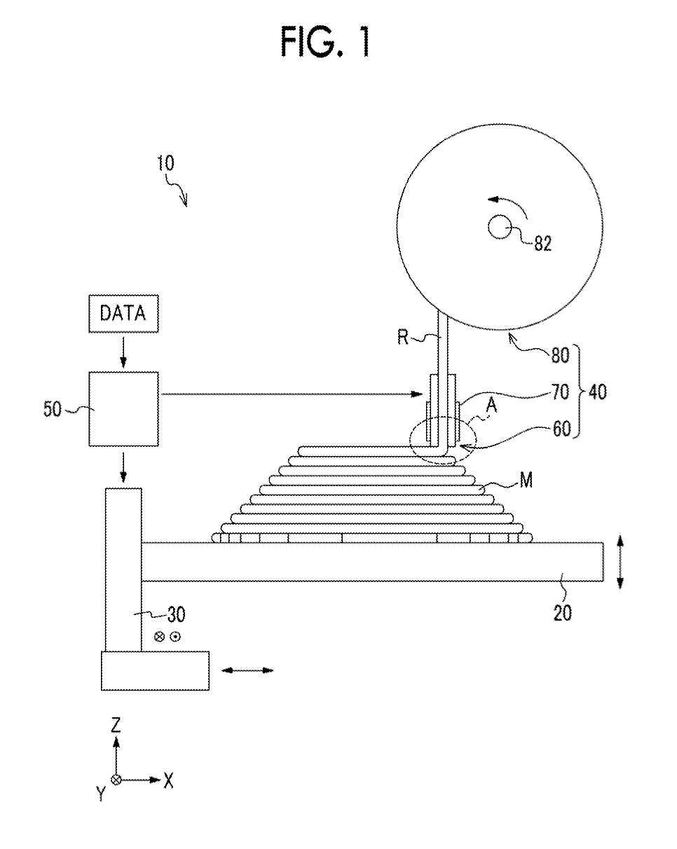

As illustrated in FIG. 1, a forming apparatus 10 of the exemplary embodiment has a function of coating a stand 20 with a resin R and manufacturing a molded article. The stand 20 and the resin R will be described later. Hereinafter, the resin R which is used in the forming apparatus 10 will be described, and an entire configuration of the forming apparatus 10 will be described.

Resin R

The resin R is a thermoplastic resin. The resin R is, for example, an acrylonitrile butadiene styrene resin.

As illustrated in FIG. 1, the resin R is formed in a thread type. The resin R is maintained in a state of being wound around a winding portion 80 which will be described later. The resin R which is maintained in the winding portion 80 is transported by a transporting portion which will be described later and is inserted into a through hole 63 of a head 60 which will be described later. The resin R which is inserted into the through hole 63 is heated by a heating portion 70 which will be described later and melted, and is ejected toward the stand 20 from an ejection port 65 which will be described later.

Entire Configuration of Forming Apparatus

As illustrated in FIG. 1, the forming apparatus 10 includes the stand 20, a moving device 30, a coating device 40, and a control device 50. Hereinafter, in the description, a Z direction in the drawing will be considered as an apparatus height direction, an X direction will be considered as an apparatus width direction, and a direction (Y direction) which intersects the Z direction and the X direction will be considered as an apparatus depth direction.

Stand

The stand 20 is a plate. The stand 20 is disposed along the apparatus width direction and the apparatus depth direction. An upper surface of the stand 20 is coated with the resin R by the coating device 40, and a molded article is manufactured on the upper surface of the stand 20. Here, the apparatus width direction and the apparatus depth direction are examples of plural directions along the stand 20.

Moving Device

The moving device 30 has a function of moving the stand 20 in the apparatus height direction, the width direction and the depth direction with respect to the coating device 40. From a different point of view, the moving device 30 relatively moves the coating device 40 with respect to the stand. Here, the moving device 30 is an example of a moving portion.

Coating Device

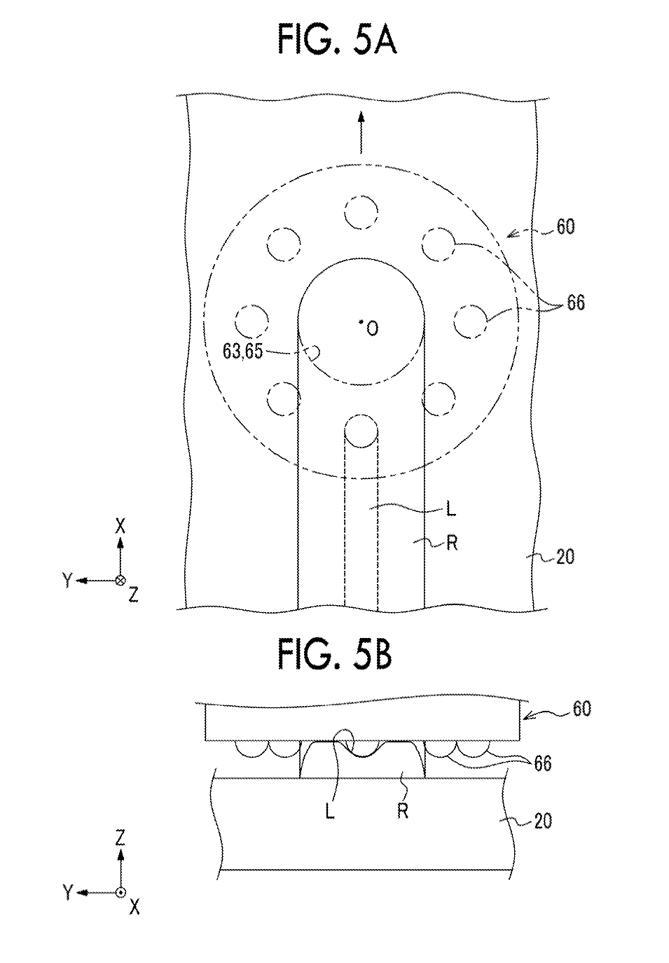

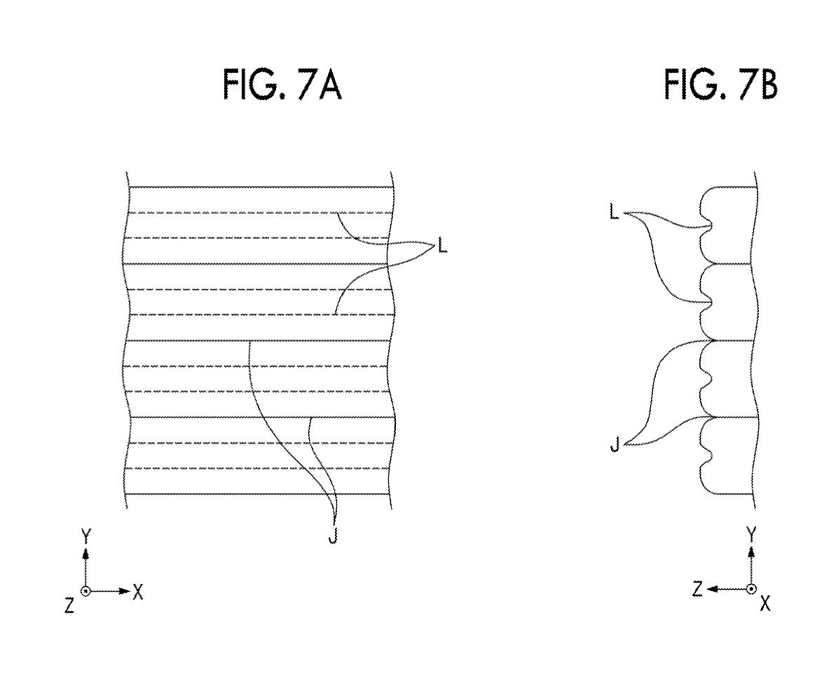

The coating device 40 has a function of being relatively moved with respect to the stand 20 by the moving device 30 while ejecting the resin R transported from the winding portion 80 from an ejection portion 62 to the stand 20, coating the stand 20 with the resin R, and forming a line L (refer to FIG. 5A and FIG. 7A) in the resin R according to the movement. Here, the line L is an example of a line which is formed in the resin R according to the relative movement of the head 60 which is an example of the coating portion, with respect to the stand 20.

The coating device 40 includes the head 60, the heating portion 70, the winding portion 80, and the transporting portion (not illustrated). Here, the head 60 is an example of the coating portion.

Head

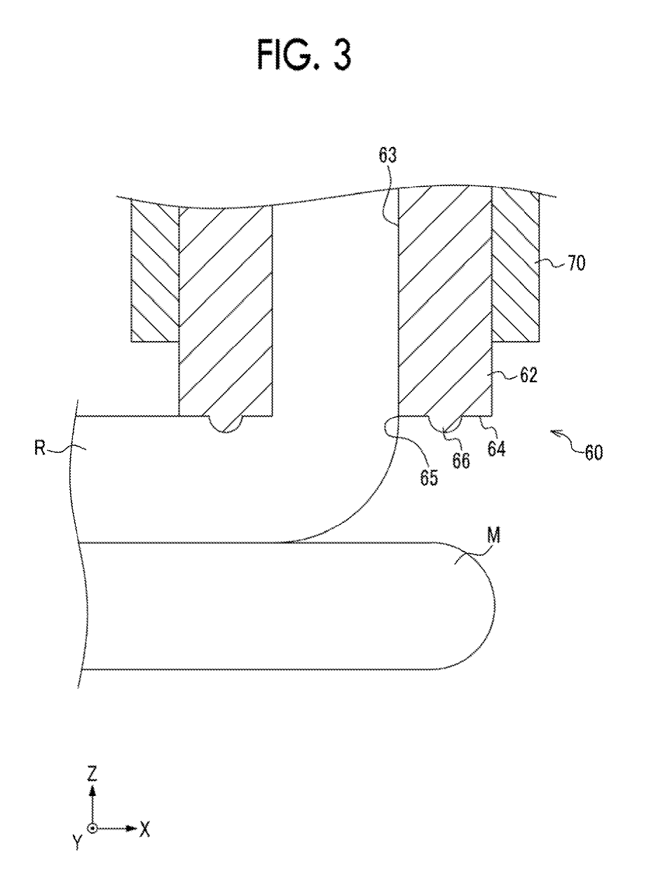

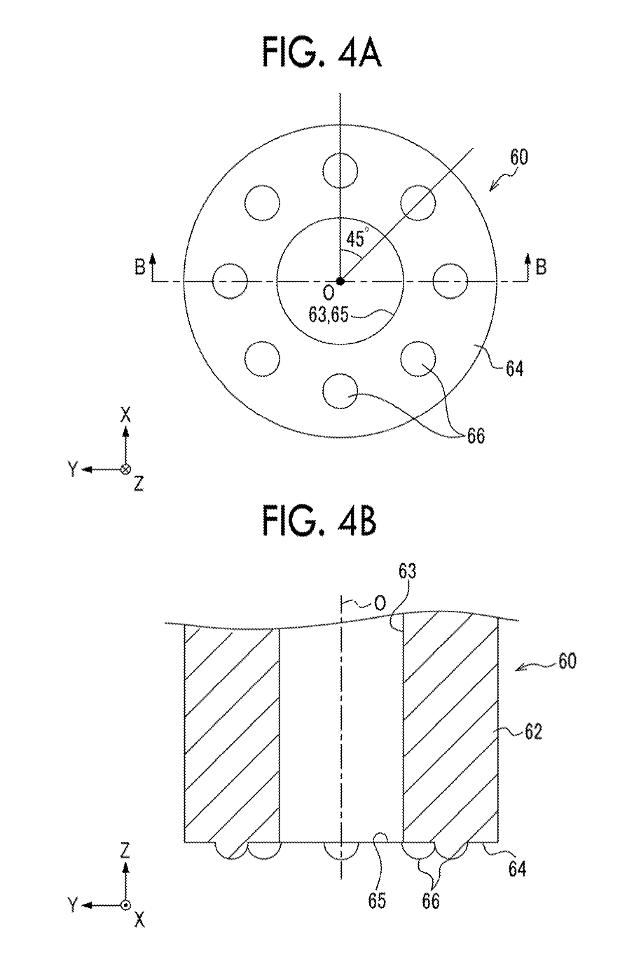

As illustrated in FIGS. 3, 4A, and 4B, the head 60 includes the ejection portion 62 and a protrusion portion 66. Here, the protrusion portion 66 is an example of a line forming portion.

Ejection Portion

The ejection portion 62 is a cylindrical body in which the through hole 63 is formed. The ejection portion 62 is disposed so that an own axis thereof is along the apparatus height direction. In addition, on a lower side of the ejection portion 62, an end surface 64 which is toward an upper surface of the stand 20 is formed. The end surface 64 is along the apparatus width direction and the apparatus depth direction. An end portion on the lower side of the through hole 63 is the ejection port 65 which ejects the resin R. Here, as illustrated in FIG. 3, a direction in which the resin R is ejected from the ejection port 65 is a lower side (−Z direction) of the apparatus height direction. As illustrated in FIG. 4A, the ejection port 65 has a circular shape. In addition, a diameter of the ejection port 65 is 0.4 mm, for example. Here, a coating width of the coated resin R is the same as the diameter of the ejection port 65.

Protrusion Portion

As illustrated in FIGS. 5A and 5S, the protrusion portion 66 has a function of forming the line L in the resin R according to the relative movement of the ejection portion 62 with respect to the stand 20. In addition, the protrusion portion 66 will be described later.

Heating Portion

The heating portion 70 has a function of heating the resin R which is inserted into the through hole 63 of the head 60 after being transported from the winding portion 80 and melting the resin R.

As illustrated in FIG. 1, the heating portion 70 is a cylindrical body which is lower than the ejection portion 62. The heating portion 70 is disposed to cover a part of an outer circumferential surface of the ejection portion 62 on the entire inner circumferential surface thereof. The heating portion 70 is configured to be supplied with electric power from an electric source (not illustrated) and to generate heat. As the heat generated by the heating portion 70 is transferred to the resin R which is inserted into the through hole 63 of the ejection portion 62 via the ejection portion 62, the heating portion 70 melts the resin R.

Winding Portion

The winding portion 80 has a function of maintaining the resin R before being inserted into the through hole 63 of the head 60 to be in a state of being wound around a rotation axis 82.

Transporting Portion

The transporting portion has a function of transporting the resin R which is maintained by the winding portion 80 while nipping the resin R by a pair of rotating rollers (not illustrated), and inserting the resin R into the through hole 63 of the ejection portion 62. The transporting portion is disposed on the upper side of the ejection portion 62.

Control Device

The control device 50 has a function of controlling other devices other than the control device 50 which constitutes the forming apparatus 10. For example, when receiving data of the molded article from a computer (not illustrated) which is an example of an external apparatus, based on the data, the control device 50 controls the moving device 30 and the coating device 40. As a result, the control device 50 controls a moving operation of the stand 20 by the moving device 30, a heating operation of the heating portion 70 which constitutes the coating device 40, a transporting operation of the transporting portion, or the like.

Supplementary Description

Hereinafter, the forming apparatus 10 will be supplementally described.

Method of Forming Apparatus 10

As described above, the coating device 40 which constitutes the forming apparatus 10 melts the resin R which is the thermoplastic resin, ejects the resin R toward the stand 20 from the ejection port 65, relatively moves the ejection portion 62 with respect to the stand 20, and coats the stand 20 with the resin R. The forming apparatus 10 laminates a layer formed of the resin R in the apparatus height direction, and manufactures a molded article which has a three-dimensional shape. In other words, the forming apparatus 10 manufactures the molded article by a so-called fused deposition modeling method.

Technical Meaning of Ejection and Coating

As described above, terms “ejection” and “coating” are used in this specification. Here, the “ejection” means that the melted resin R is ejected from the ejection port 65 of the ejection portion 62 toward the stand 20. In contrast, the “coating” means that the resin R is disposed on the stand 20 along the apparatus width direction and the apparatus depth direction, by relatively moving the ejection portion 62 with respect to the stand 20 and ejecting the resin R from the ejection port 65. In addition, forming the above-described layer with the resin R is one aspect of performing coating with the resin R.

Above, the entire configuration of the forming apparatus 10 is described.

Operations of Forming Apparatus

Next, operations (manufacturing method of the molded article by using the forming apparatus 10) of the forming apparatus 10 will be described with reference to the drawings. Hereinafter, a case where a circular truncated cone M which is an example of the molded article is manufactured by using the forming apparatus 10 will be described.

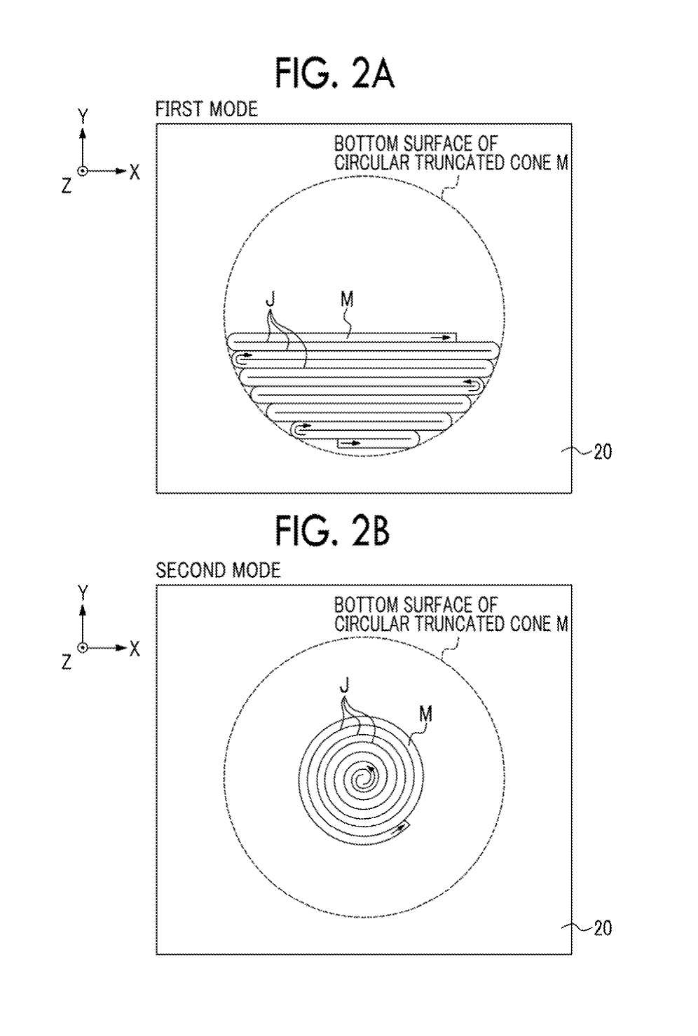

When the data of the circular truncated cone M is received from the computer (not illustrated), the control device 50 calculates a route in which the ejection portion 62 is relatively moved with respect to the stand 20. In this case, since there are plural routes for manufacturing the circular truncated cone M (refer to FIGS. 2A and 2B), the control device 50 notifies the plural routes to an operator as a first mode and a second mode by a display device (not illustrated). Then, the operator pushes a select button (not illustrated) of the forming apparatus 10, and selects which mode the operator manufactures the circular truncated cone M in.

Next, the control device 50 moves the heating portion 70 and the transporting portion. Then, the resin R which is transported and inserted into the through hole 63 of the ejection portion 62 by the transporting portion is melted by the heat generated by the heating portion 70.

Case where First Mode is Selected

First, a case where the operator selects the first mode is described. As illustrated in FIG. 2A, the coating device 40 ejects the melted resin R from the ejection port 65, relatively moves the ejection portion 62 in one direction of the apparatus width direction, the apparatus depth direction, and the other direction of the apparatus width direction in this order with respect to the stand 20, and coats the stand 20 with the resin R. The forming apparatus 10 forms a layer of the resin R. At this time, a moving distance of the ejection portion 62 in the apparatus depth direction is considered as a distance which corresponds to the diameter of the ejection port 65. For this reason, coating is performed with the adjacent resins R along the apparatus width direction in a contact state.

Next, after forming the layer of the resin R, the forming apparatus 10 moves the ejection portion 62 in the apparatus height direction with respect to the stand 20, and forms a layer of different resin R on the layer of the resin R. When forming the layer of different resin R, the ejection port 65 moves from a depth side to a near side of the apparatus depth direction while moving in the apparatus width direction. Then, if the above-described operations are repeated, plural layers of the resins R are laminated in the apparatus height direction, and the resin R is naturally cooled and hardened, then, the circular truncated cone M is completed. In addition, FIG. 1 illustrates a state where the forming apparatus 10 manufactures the circular truncated cone M in the first mode.

Case where Second Mode is Selected

Next, a case where the operator selects the second mode is described. As illustrated in FIG. 23, the coating device 40 ejects the melted resin R from the ejection port 65, relatively moves the ejection portion 62 with respect to the stand 20 to swirl toward the outer circumferential surface from a center of a bottom surface of the circular truncated cone M, and coats the stand 20 with the resin R. Then, the forming apparatus 10 forms the layer of the resin R. At this time, coating is performed with the adjacent resins R in a contact state.

Next, after forming the layer of the resin R, the layer of different resin R is formed on the layer of the resin R as the ejection portion 62 is moved in the apparatus height direction with respect to the stand 20. When forming the layer of different resin R, the ejection port 65 is moved to swirl toward the center from the outer circumferential surface side. Then, if the above-described operations are repeated, the plural layers of the resins R are laminated in the apparatus height direction, and the resin R is naturally cooled and hardened, then, the circular truncated cone M is completed.

Above, the operations of the forming apparatus 10 are described. In addition, even in any mode, the end surface 64 of the ejection portion 62 moves while being in contact with the ejected resin R.

Configuration of Protrusion Portion

Next, a configuration of the protrusion portion will be described in detail with reference to the drawings.

As illustrated in FIGS. 3 and 4B, the protrusion portion 66 protrudes further lower than the ejection port 65 in the apparatus height direction. As illustrated in FIGS. 3, 4A, and 4B, the protrusion portion 66 has a hemispherical shape. The protrusion portion 66 is formed on the end surface 64 of the ejection portion 62. In addition, a height from the end surface 64 of the protrusion portion 66 is 50 μm. In addition, a maximum diameter (diameter of a boundary part between the end surface 64 and the protrusion portion 66) of the protrusion portion 66 is configured to be smaller than the diameter of the ejection port 65.

In addition, plural (eight) protrusion portions 66 are provided. When viewed from a lower side of the apparatus height direction, each of the protrusion portions 66 is disposed to have a constant distance from an own axis O, be shifted by 45° around the own axis O of the ejection portion 62, and surround the ejection port 65. For this reason, for example, when the head 60 relatively moves with respect to the stand 20 in the second mode, in other words, even when the head 60 moves in any direction on a plane by considering the apparatus width direction as a reference, the protrusion portion 66 is interfered with by the resin R ejected from the ejection port 65. In other words, when the head 60 moves in plural directions on the plane with respect to the stand 20, at least one of the provided plural protrusion portions 66 is configured to be in contact with the resin R ejected from the ejection port 65 and form the line L. In addition, in a radial direction of the end surface 64, each of the protrusion portions 66 is disposed at an intermediate part between an inner circumferential edge and an outer circumferential edge of the ejection portion 62.

Operations

Next, operations of the exemplary embodiment will be described with reference to the drawings. In the description below, the exemplary embodiment and the comparative example which is assumed hereinafter will be compared to each other. In addition, in the comparative example, in a case where components or the like which are used in the forming apparatus 10 of the exemplary embodiment are used, the same reference numerals of the components and the same name of each process will be used in the description.

### Comparative Example

A forming apparatus (hereinafter, referred to as a comparative apparatus) of the comparative example is different from the forming apparatus 10 in that the protrusion portion 66 is not provided in the end surface 64 of the ejection portion 62. Other than this, the comparative apparatus is configured in a similar manner to the forming apparatus 10.

In addition, a manufacturing method of a molded article of the comparative example is different from the manufacturing method of the molded article of the exemplary embodiment in that the molded article is manufactured by using the comparative apparatus. Other than this, the manufacturing method of the molded article of the comparative example is configured in a similar manner to the manufacturing method of the molded article of the exemplary embodiment.

When manufacturing the molded article in a first mode by using the comparative apparatus (hereinafter, referred to as a comparative manufacturing method 1), a line J which depends on the diameter of the ejection port 65 is formed in the molded article. In other words, in the comparative manufacturing method 1, the line J which depends on the coating width is formed in the molded article.

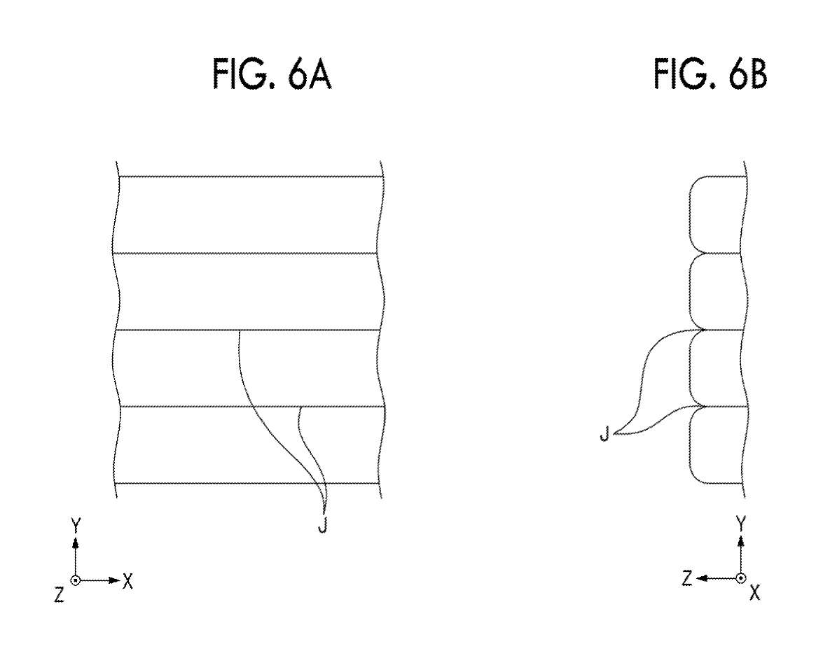

Here, FIGS. 6A and 6B illustrate a state of an upper surface of the circular truncated cone M which is manufactured by the comparative manufacturing method 1. In addition, as described above, since the diameter of the ejection port 65 is 0.4 mm, on the upper surface of the circular truncated cone M, as illustrated in FIG. 2A, at a pitch of 0.4 mm, that is, at the coating width, the line J having a straight line shape is formed. The line J is remarkably and visually recognized.

In addition, even when manufacturing the molded article in a second mode by using the comparative apparatus (hereinafter, referred to as a comparative manufacturing method 2), like in the comparative manufacturing method 1, the line J is formed in the circular truncated cone M. On the upper surface of the circular truncated cone M, as illustrated in FIG. 2B, at a pitch of 0.4 mm, that is, at the coating width, the line J having a curved line shape is formed. The line J is remarkably and visually recognized.

Operations when Head has Protrusion Portion

In contrast, if the circular truncated cone M is manufactured in the first mode and the second mode by using the forming apparatus 10, similarly to the comparative manufacturing methods 1 and 2, the line J is formed on the upper surface of the circular truncated cone M. However, if the circular truncated cone M is manufactured in the first mode and the second mode by using the forming apparatus 10, with respect to the resin R ejected to the stand 20 from the ejection port 65, the protrusion portion 66 is interfered with, and coating is performed with the resin R in which the line L is formed by the protrusion portion 66. For this reason, when coating is performed with the resin R in the first mode by using the forming apparatus 10, as illustrated in FIGS. 5A and 5B, the line L is formed in the resin R after coating according to the relative movement of the ejection portion 62 with respect to the stand 20. As a result, as illustrated in FIGS. 7A and 7B, on the upper surface of the circular truncated cone M, between the lines J, the line L is formed.

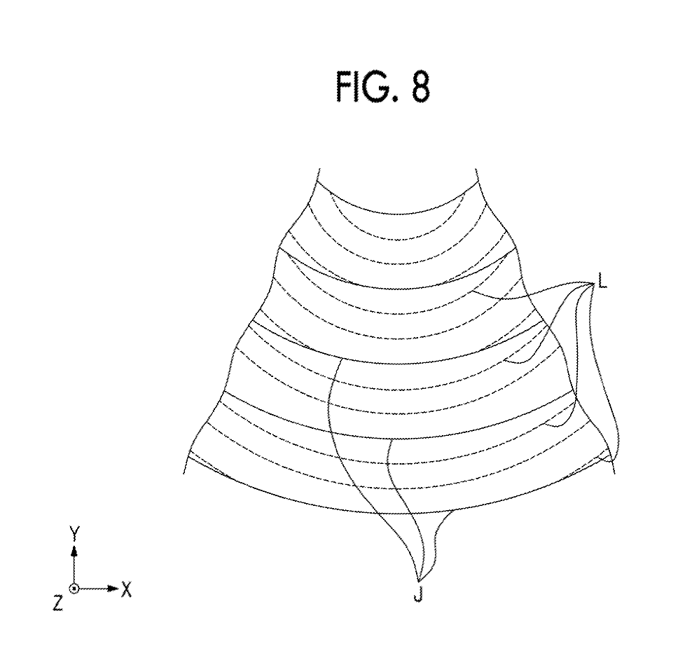

In addition, when coating is performed with the resin R in the second mode by using the forming apparatus 10, as illustrated in FIG. 8, the line L is formed in the resin R after coating according to the relative movement of the ejection portion 62 with respect to the stand 20. As a result, as illustrated in FIG. 8, on the upper surface of the circular truncated cone M, between the lines J, the line L is formed. In addition, when manufacturing the circular truncated cone M in the first mode by using the forming apparatus 10, as illustrated in FIG. 7A, the line L is formed along the line J. Meanwhile, when manufacturing the circular truncated cone M in the second mode, as illustrated in FIG. 8, the line L is not formed along the line J (the line L which is changed at a larger curvature than that of the line J is formed).

Therefore, when manufacturing the molded article by using the forming apparatus 10 (according to the manufacturing method of the molded article of the exemplary embodiment), compared to the comparative manufacturing methods 1 and 2, it is possible to manufacture the molded article in which the line J is unlikely to stand out. In other words, according to the forming apparatus 10, compared to the comparative apparatus, it is possible to manufacture the molded article in which the line J is unlikely to stand out. In addition, as described above, when manufacturing the circular truncated cone M in the second mode, the line L is not formed along the line J. For this reason, when manufacturing the molded article in the second mode by using the forming apparatus 10, compared to a case where the molded article is manufactured in the first mode, it is possible to manufacture the molded article in which the line J is unlikely to stand out.

Operations when Plural. Protrusion Portions are Provided to Surround Ejection Port

In addition, in the end surface 64 of the ejection portion 62 of the forming apparatus 10, the plural protrusion portions 66 are provided to surround the ejection port 65. In addition, as described above, even when the head 60 moves in any direction on the plane with respect to the stand 20, for example, in a case of the second mode, at least one of the provided plural protrusion portions 66 is configured to be in contact with the resin R ejected from the ejection port 65 and form the line L.

Therefore, according to the manufacturing method of the molded article of the exemplary embodiment, compared to the comparative manufacturing methods 1 and 2, even when the head 60 relatively moves in any direction along the stand 20 with respect to the stand 20, it is possible to manufacture the molded article in which the line J is unlikely to stand out. In other words, according to the forming apparatus 10, compared to the comparative apparatus, even when the head 60 relatively moves in any direction along the stand 20 with respect to the stand 20, it is possible to manufacture the molded article in which the line J is unlikely to stand out.

### First Modification Example of First Exemplary Embodiment

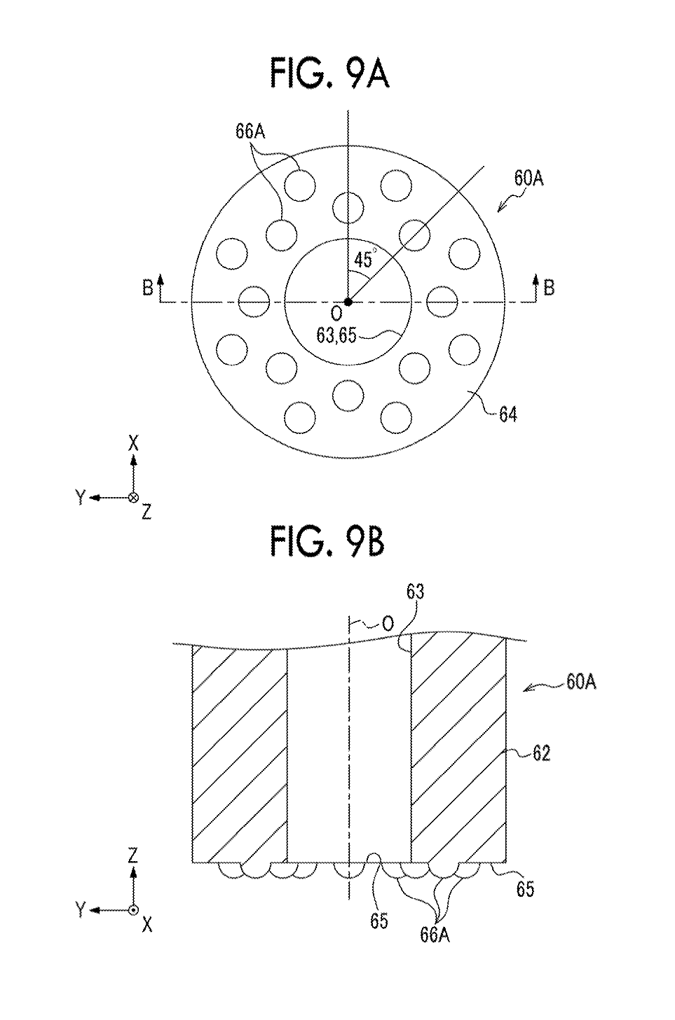

Next, a first modification example of the first exemplary embodiment will be described with reference to FIGS. 9A and 9B. In addition, in the modification example, in a case where the components or the like which are used in the forming apparatus 10 of the first exemplary embodiment are used, the same reference numerals of the components and the same name of each process will be used in the description.

Configuration

Plural (sixteen) protrusion portions 66A of a head 60A of the modification example are formed in the end surface 64 of the ejection portion 62. Here, the head 60A is an example of the coating portion. In addition, the protrusion portion 66A is an example of a line forming portion. In addition, the protrusion portion 66A has a similar shape to that of the protrusion portion 66 of the first exemplary embodiment. In other words, the maximum diameter of the protrusion portion 66 is smaller than the diameter of the ejection port 65. When viewed from the lower side of the apparatus height direction, half of the sixteen protrusion portions 66A are disposed to have a constant distance from the own axis O, approach the inner circumferential edge side of the end surface 64, be shifted by 45° around the own axis O, and surround the ejection port 65. In addition, when viewed from the lower side of the apparatus height direction, the remaining half of the sixteen protrusion portions 66A are disposed to have a constant distance from the own axis O, approach the outer circumferential edge side of the end surface 64, be shifted by 45° around the own axis O, and surround the ejection port 65. A phase of the above-described half of the protrusion portions 66A and the above-described remaining half is shifted by 22.5° in a circumferential direction. When the head 60A moves in any direction on the plane with respect to the stand 20, at least two among the protrusion portions 66A are configured to be in contact with the resin R ejected from the ejection port 65 and form the line L. Other configurations of the forming apparatus of the modification example are similar to the configuration of the first exemplary embodiment.

In addition, the manufacturing method of the molded article of the modification example is different from the manufacturing method of the molded article of the exemplary embodiment in that the molded article is manufactured by using the forming apparatus of the modification example. Other than this, the manufacturing method of the molded article of the modification example is configured in a similar manner to the manufacturing method of the molded article of the first exemplary embodiment.

Operations

When coating is performed with the resin R by the forming apparatus of the modification example, at least two or more protrusion portions 66A are in contact with the resin R and at least two or more lines L are formed in the resin R after coating.

For this reason, when manufacturing the molded article by using the manufacturing apparatus of the modification example, compared to a case where the molded article is manufactured by using the forming apparatus 10 of the first exemplary embodiment, it is possible to manufacture the molded article in which a line which depends on the coating width of the resin R is unlikely to stand out.

Other operations of the modification example are similar to the operations of the first exemplary embodiment.

### Second Modification Example of First Exemplary Embodiment

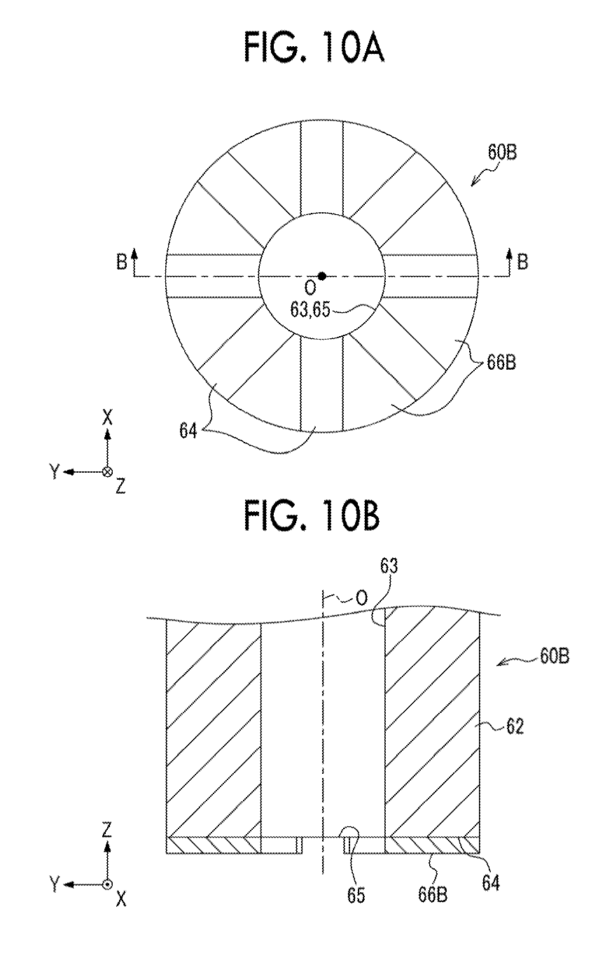

Next, a second modification example of the first exemplary embodiment will be described with reference to FIGS. 10A and 10B. In addition, in the modification example, in a case where the components or the like which are used in the forming apparatus 10 of the first exemplary embodiment are used, the same reference numerals of the components and the same name of each process will be used in the description.

Configuration

Eight protrusion portions 66B of a head 60B of the modification example are formed in the end surface 64 of the ejection portion 62. Here, the head 60B is an example of the coating portion. In addition, the protrusion portion 66B is an example of the line forming portion.

Here, processing of the protrusion portion 66B will be described. An end surface of the cylindrical body in which the through hole 63 is formed is cut by a cutting processing device (not illustrated) from a direction which is different by 45° in angle from a straight line that passes through a center O of the cylindrical body, and a recessed part having a line shape is formed. As a result, when the ejection portion 62 is viewed from the lower side of the apparatus height direction, by considering the own axis O as a center, the recessed part (end surface 64) having a long shape along the radial direction is shifted by 45° around the own axis O, and surrounds the ejection port 65. Then, the remaining part which is not cut is formed as the protrusion portion 66B.

Operations

Compared to the above-described protrusion portion 66 of the head 60 and the protrusion portion 66A of the head 60A, the protrusion portion 66B of the head 60B of the modification example is easily processed. For this reason, it is easy to manufacture the head 60B of the modification example and the manufacturing apparatus of the modification example. Other operations of the modification example are similar to the operations of the first exemplary embodiment.

### Third Modification Example of First Exemplary Embodiment

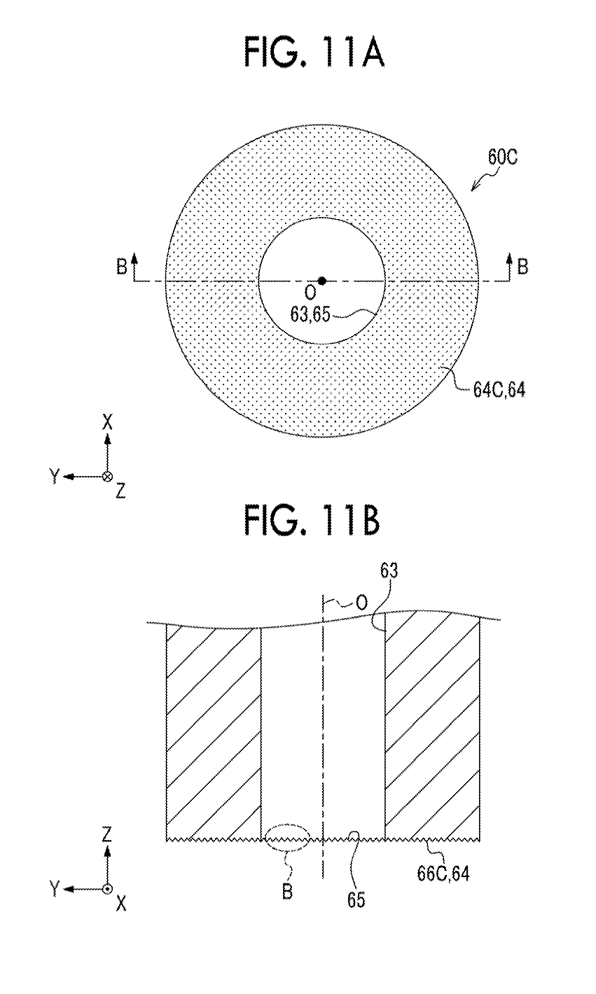

Next, a third modification example of the first exemplary embodiment will be described with reference to FIGS. 11A and 11B. In addition, in the modification example, in a case where the components or the like which are used in the forming apparatus 10 of the first exemplary embodiment are used, the same reference numerals of the components and the same name of each process will be used in the description.

Configuration

In the end surface 64 of a head 60C of the modification example, an unevenness portion 66C in which a roughness of a front surface is from 5 μm to 100 μm is formed. Here, the head 60C is an example of the coating portion. In addition, the unevenness portion 66C is an example of the line forming portion. The end surface 64 of the head 60C of the modification example is a surface on which the unevenness portion 66C is formed, that is, the unevenness portion 66C. For this reason, the unevenness portion 66C surrounds the ejection port 65. Here, the roughness of the front surface is a ten point average roughness Rz (refer to JISB 0601-1994). Other configurations of the forming apparatus of the modification example are similar to the configuration of the forming apparatus 10 of the first exemplary embodiment.

Operations

When coating is performed with the resin R by the forming apparatus of the modification example, the unevenness portion 66C is in contact with the resin R and the multiple lines L are formed in the resin R after coating. In addition, when manufacturing the molded article by using the forming apparatus of the modification example, compared to a case where the molded article is manufactured by using the forming apparatus 10 of the first exemplary embodiment, and the forming apparatus of the first and the second modification examples, it is possible to manufacture the molded article in which the front surface of the resin R has a mat tone (a state where light which is incident on the front surface is likely to be reflected in a scattered manner). Other operations of the modification example are similar to the operations of the first exemplary embodiment.

### Fourth Modification Example of First Exemplary Embodiment

Configuration

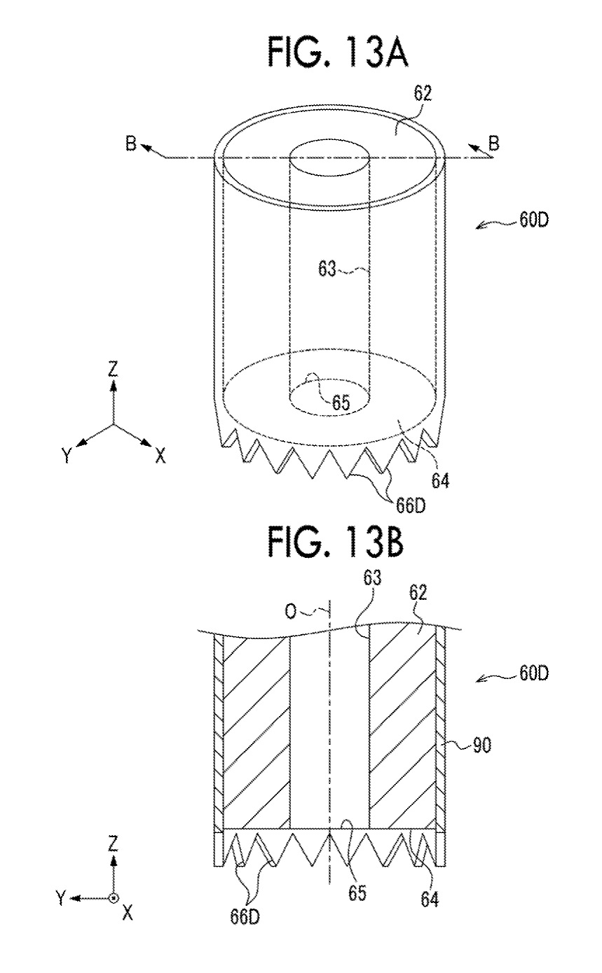

Next, a fourth modification example of the first exemplary embodiment will be described with reference to FIGS. 13A and 13B. In addition, in the modification example, in a case where the components or the like which are used in the forming apparatus 10 of the first exemplary embodiment are used, the same reference numerals of the components and the same name of each process will be used in the description.

Configuration

A head 60D of the modification example is configured to include the ejection portion 62 and a pipe portion 90. Here, the head 60D is an example of the coating portion. In the end surface 64 of the ejection portion 62, the protrusion portion is not formed. In addition, the pipe portion 90 is disposed to surround the outer circumferential surface of the ejection portion 62. An inner circumferential surface of the pipe portion 90 is adhered and fixed to the outer circumferential surface of the ejection portion 62. A lower side end portion of the pipe portion 90 protrudes further lower than the end surface 64 in the apparatus height direction. At the lower side end portion of the pipe portion 90, a projection 66D which protrudes toward the stand 20 is formed. When viewed from the apparatus width direction or the apparatus depth direction, the projection 66D has a triangle shape in which a top point is formed toward the stand 20. Here, the projection 66D is an example of the protrusion portion and the line forming portion. Plural projections 66D are provided to surround the end surface 64 of the ejection portion 62. For this reason, from a different point of view, the end surface 64 and the ejection port 65 are surrounded by teeth which are configured of the plural projections 66D. Other configurations of the manufacturing apparatus of the modification example are similar to the configuration of the forming apparatus 10 of the first exemplary embodiment.

Operations

The projection 66D of the modification example is formed at the lower side end portion of the pipe portion 90 which is not the end surface 64 of the ejection portion 62 and is a different member of the ejection portion 62. For this reason, compared to the protrusion portion 66 of the first exemplary embodiment and the protrusion portion 66A of the first modification example, it is easy to manufacture the projection 66D of the modification example. Other operations of the modification example are similar to the operations of the first exemplary embodiment.

### Second Exemplary Embodiment

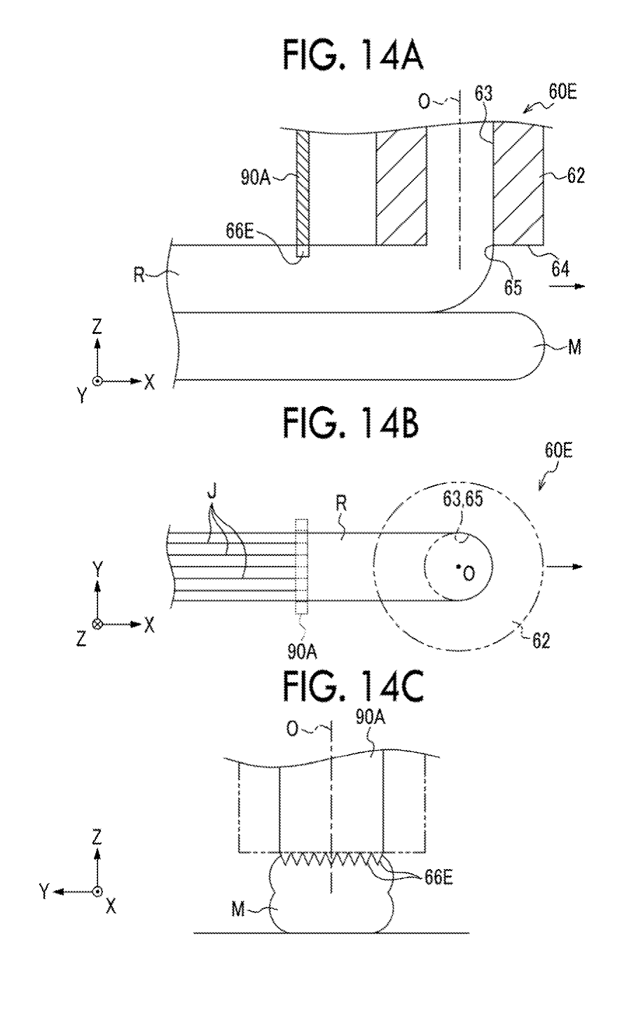

Next, a second exemplary embodiment will be described with reference to FIGS. 14A, 14B, and 14C. In addition, in the exemplary embodiment, in a case where the components or the like which are used in the forming apparatus 10 of the first exemplary embodiment are used, the same reference numerals of the components and the same name of each process will be used in the description.

Configuration

A head 60E of the exemplary embodiment is configured to include the ejection portion 62 and a plate portion 90A. Here, the head 60E is an example of the coating portion. The end surface 64 of the ejection portion 62 is a plane. In addition, the plate portion 90A has a long shape. The plate portion 90A extends along the apparatus height direction, and is disposed to be apart from the ejection portion 62. The lower side end portion of the plate portion 90A protrudes further lower than the ejection port 65 (end surface 64) in the apparatus height direction. In the lower side end portion of the plate portion 90A, a projection 66E which protrudes toward the stand 20 is formed. When viewed from a plate thickness direction of the plate portion 90A, the projection 66E has a triangle shape in which a top point is formed toward the stand 20. Here, the projection 66E is an example of the line forming portion. Plural projections 66E are provided along the straight line direction. For this reason, from a different point of view, in the lower side end portion of the plate portion 90A, the teeth which are configured of the plural projections 66D are formed. In addition, as illustrated in FIGS. 14B and 14C, an interval between the projections 66E is narrower than an ejection width (coating width) of the resin R.

In addition, an upper side end portion of the plate portion 90A is supported by a supporting portion (not illustrated) which is attached to be rotatable on the outer circumferential surface of the ejection portion 62. The supporting portion is driven by a driving source (not illustrated), and is rotated around the own axis of the ejection portion 62. In addition, the supporting portion is controlled by the control device 50. When manufacturing the molded article by using the head 60E of the modification example, the plate portion 90A is disposed on the resin R so that the control device 50 rotates the supporting portion around the own axis of the ejection portion 62, and the provided plural projections 66E are in contact with the resin R ejected from the ejection portion 62 to the head 60E on an upstream side of the moving direction of the head 60E. Other configurations of the forming apparatus of the exemplary embodiment are similar to the configuration of the forming apparatus 10 of the first exemplary embodiment.

Operations

When manufacturing the molded article by using the forming apparatus of the exemplary embodiment, the plate portion 90A is moved so that the projection 66E is in contact with the resin R ejected from the ejection portion 62 on the upstream side of the moving direction. For this reason, the head 60E of the modification example is different from the heads 60, and 60A to 60D of the first exemplary embodiment and the first to the fourth modification examples, and it is not required that the protrusion portion 66 be disposed to surround the ejection port 65.

In addition, when manufacturing the molded article in the second mode by using the forming apparatus of the exemplary embodiment, while moving the plate portion 90A along a direction in which the head 60E relatively moves with respect to the stand 20, it is possible to perform coating. For this reason, when manufacturing the molded article in the second mode by using the forming apparatus of the exemplary embodiment, the line L is formed along the line J.

The operations of the exemplary embodiment are similar to the operations of the first exemplary embodiment and the first to the fourth modification examples.

### Third Exemplary Embodiment and Modification Examples Thereof

Next, a third exemplary embodiment and modification examples thereof will be described with reference to the drawings. In addition, in the exemplary embodiment, in a case where the components or the like which are used in the forming apparatus 10 of the first exemplary embodiment are used, the same reference numerals of the components and the same name of each process will be used in the description.

### Third Exemplary Embodiment

### Configuration

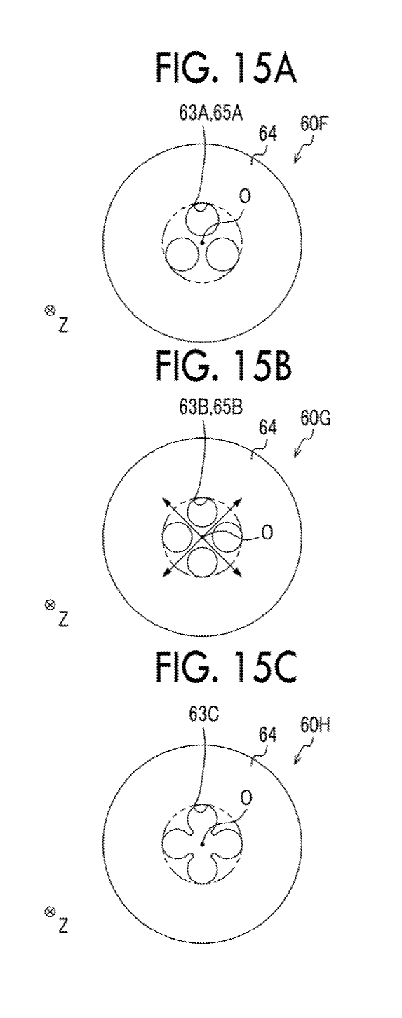

A head 60F of the exemplary embodiment is a columnar body. Here, the head 60F is an example of the coating portion. As illustrated in FIG. 15A, in the head 60F, a through hole 63A is formed along the own axis O. In the columnar body, three through holes 63A are formed. When viewed from the apparatus height direction, each of the through holes 63A has a circular shape. When viewed from the lower side of the apparatus height direction, by considering the own axis O as a center, each of the through holes 63A is disposed with equivalent intervals in the circumferential direction. The end portion of the end surface 64 in each of the through holes 63A is each of ejection ports 65A. For this reason, in the head 60F, by considering the own axis O as a center, the three ejection ports 65A are formed with equivalent intervals in the circumferential direction. Here, the coating width of the coated resin R is the same as a diameter of a virtual circle (virtual circle of a two dot dashed line in the drawing) which surrounds each of the ejection ports 65A by considering the own axis O as a center and comes into contact with each of the ejection ports 65A.

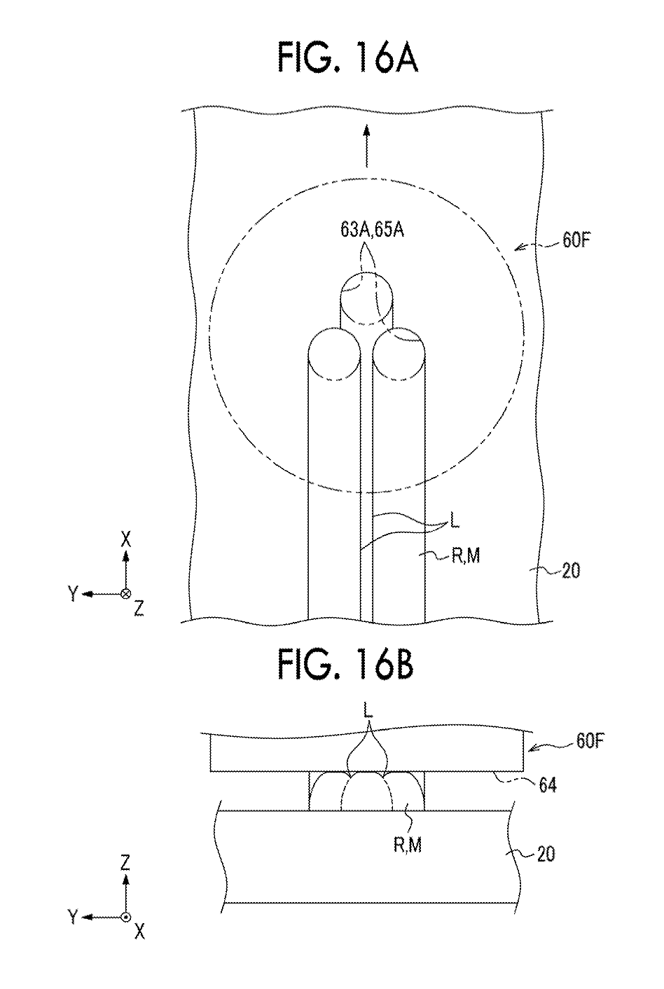

In addition, when looking through each of the through holes 63A from any radial direction by considering the own axis O as a center, each of the through holes 63A is overlapped with at least one of the other through holes 63A. As illustrated in FIGS. 16A and 16B, even when the head 60F relatively moves in any direction of the radial direction with respect to the stand 20, coating is performed with the resin R which is ejected from the ejection port 65A to be overlapped (the line L is formed). For this reason, the head 60F is configured to form the line L in the resin R according to the ejection while relatively moving with respect to the stand 20, that is, the stand 20 is coated with the resin R according to the relative movement and the ejection. Here, “the line L is formed in the resin R according to the ejection” means that the line L is formed in the resin R because of the ejection operation. In other words, in a case where the molded article is manufactured by using the head 60F of the exemplary embodiment, for example, like a case where the molded article is manufactured by using the head 60 of the first exemplary embodiment, even when the protrusion portion 66 is not interfered with by the resin R ejected from the ejection port 65, the line L is formed in the resin R after coating. In addition, the end surface 64 of the head 60F is the plane, that is, a protrusion portion is not formed. In addition, the above-described virtual circle illustrated by the two dot dashed line illustrates the end portion of the ejection port 65 in the head 60 of the first exemplary embodiment.

Other configurations of the forming apparatus of the exemplary embodiment are similar to the configuration of the forming apparatus 10 of the first exemplary embodiment.

Operations

If the molded article is manufactured by using the forming apparatus of the exemplary embodiment, when coating is performed with the resin R, the line L is formed in the resin R according to the ejection. Therefore, according to the manufacturing method of the molded article by using the forming apparatus of the exemplary embodiment, compared to the comparative manufacturing methods 1 and 2, it is possible to manufacture the molded article in which the line J is unlikely to stand out. In other words, according to the forming apparatus of the exemplary embodiment, compared to the comparative apparatus, it is possible to manufacture the molded article in which the line J is unlikely to stand out.

In addition, as illustrated in FIGS. 16A and 16B, even when the head 60F relatively moves in any direction with respect to the stand 20, coating is performed with the resin R ejected from the ejection port 65A of the exemplary embodiment to be overlapped. Therefore, according to the manufacturing method of the molded article of the exemplary embodiment, compared to the comparative manufacturing methods 1 and 2, even when the head 60F relatively moves in any direction along the stand 20 with respect to the stand 20, it is possible to manufacture the molded article in which the line J is unlikely to stand out. In other words, according to the forming apparatus of the exemplary embodiment, compared to the comparative apparatus, even when the head 60F relatively moves in any direction along the stand 20 with respect to the stand 20, it is possible to manufacture the molded article in which the line J is unlikely to stand out.

Other operations of the exemplary embodiment are similar to the operations of the first exemplary embodiment, the first to the fourth modification examples of the first exemplary embodiment, and the second exemplary embodiment.

### First Modification Example of Third Exemplary Embodiment

Next, a first modification example of the third exemplary embodiment will be described with reference to FIG. 15B. In addition, in the modification example, in a case where the components or the like which are used in the forming apparatus 10 of the first exemplary embodiment and in the forming apparatus of the third exemplary embodiment are used, the same reference numerals of the components and the same name of each process will be used in the description.

Configuration

A head 60G of the modification example is a columnar body. Here, the head 60G is an example of the coating portion. As illustrated in FIG. 15B, in an ejection portion 62B, a through hole 63B is formed along the own axis O. In the columnar body, four through holes 63B are formed. When viewed from the apparatus height direction, each of the through holes 63B has a circular shape. When viewed from the lower side of the apparatus height direction, by considering the own axis O as a center, each of the through holes 63B is disposed with equivalent intervals in the circumferential direction. The end portion of the end surface 64 in each of the through holes 63B is an ejection port 65B. For this reason, in the head 60G, by considering the own axis O as a center, the four ejection ports 65B are formed with equivalent intervals in the circumferential direction. Here, the coating width of the coated resin R is the same as the diameter of the virtual circle (virtual circle of a two dot dashed line in the drawing) which surrounds each of the ejection ports 65B by considering the own axis O as a center and comes into contact with each of the ejection ports 65B.

In addition, when looking through each of the through holes 63B from any radial direction by considering the own axis O as a center, each of the through holes 63B is overlapped with at least one of the other through holes 63B. When the head 60G relatively moves in a preset direction of the radial direction with respect to the stand 20, coating is performed with the resin R which is ejected from each of the ejection ports 65B to be overlapped. For this reason, the head 60G is configured to form the line L in the resin R according to the ejection while relatively moving with respect to the stand 20, that is, the stand 20 is coated with the resin R according to the relative movement and the ejection. In addition, the end surface 64 of the ejection portion 62B is a plane, that is, the protrusion portion is not formed. In addition, the above-described virtual circle illustrated by the two dot dashed line illustrates the end portion of the ejection port 65 in the head 60 of the first exemplary embodiment.

In addition, the above-described preset direction is a direction other than arrow directions in FIG. 15B. When the head 60G of the modification example is relatively moved in the arrow directions in FIG. 15B with respect to the stand 20, the resin R ejected from each of the ejection ports 65B is overlapped two by two, but coating is performed with the resin R in a state where the resin R is divided into two. For this reason, when manufacturing the molded article by using the head 60G of the modification example, it is required that the head 60G be relatively moved in the preset direction with respect to the stand 20.

Other configurations of the forming apparatus of the modification example are similar to the configuration of the forming apparatus 10 of the first exemplary embodiment.

Operations

Operations of the modification example are similar to the operations of the first exemplary embodiment, the first to the fourth modification examples of the first exemplary embodiment, the second exemplary embodiment, and the third exemplary embodiment.

### Second Modification Example of Third Exemplary Embodiment

Next, a second modification example of the third exemplary embodiment will be described with reference to FIG. 15C. In addition, in the modification example, in a case where the components or the like which are used in the forming apparatus 10 of the first exemplary embodiment and in the forming apparatus of the third exemplary embodiment and the first modification example are used, the same reference numerals of the components and the same name of each process will be used in the description.

Configuration

A head 60H of the modification example is a columnar body. Here, the head 60H is an example of the coating portion. As illustrated in FIG. 15C, in the head 60H of the exemplary embodiment, when viewed from the lower side of the apparatus height direction, a through hole 63C is formed in a cross shape. In addition, from a different point of view, as the through hole 63C penetrates the center of the own axis O of the head 60G in the first modification example, it is possible to consider the through hole 63C as a through hole which connects the inner circumferential surfaces of the four through holes 63B.

In addition, when the head 60H is relatively moved with respect to the stand 20 while ejecting the resin R, and the stand 20 is coated with the resin R, the coating is performed with the coated resin R in a state of having a different height from that of the stand 20 in a direction which intersects the moving direction of the head 60H. For this reason, the head 60H is configured so that the line L is formed in the resin R according to the ejection, and the stand 20 is coated with the resin R. In addition, the end surface 64 of the head 60H is a plane, that is, the protrusion portion is not formed. In addition, a two dot chain line in FIG. 15C illustrates the end portion of the ejection port 65 in the head 60 of the first exemplary embodiment.

Other configurations of the forming apparatus of the modification example are similar to the configurations of the forming apparatus 10 of the first exemplary embodiment, the forming apparatus of the third exemplary embodiment, and the forming apparatus of the first modification example of the third exemplary embodiment.

Operations

Operations of the modification example are similar to the operations of the first exemplary embodiment, the first to the fourth modification examples of the first exemplary embodiment, the second exemplary embodiment, and the first and the second modification examples of the third exemplary embodiment.

### Supplementary Description (Relationship Between First Exemplary Embodiment and Modification Examples Thereof, and Third Exemplary Embodiment and Modification Examples Thereof)

As described above, according to the forming apparatus of the first exemplary embodiment and the modification examples thereof, and the third exemplary embodiment and the modification examples thereof, compared to the comparative apparatus, it is possible to manufacture the molded article in which the line J is unlikely to stand out.

Here, when comparing the first exemplary embodiment and the modification examples thereof, and the third exemplary embodiment and the modification examples thereof, the former has a lager opening area of the ejection port compared to the latter. For this reason, the former may manufacture the molded article in which the line J is unlikely to stand out in a short period of time compared to the latter.

As described above, certain exemplary embodiments of the invention are described in detail, but the invention is not limited to the above-described exemplary embodiments. It is possible to employ other exemplary embodiments within the range of the technical idea of the invention.

For example, the molded article manufactured by using the forming apparatuses in each exemplary embodiment is described as a molded article having a three-dimensional shape. However, if the stand 20 is coated with the resin R while the ejection of the resin R is performed and the relative movement with respect to the stand 20 is performed, and if the line L is formed in the resin R according to the ejection or the relative movement of the coating device 40 with respect to the stand 20, the molded article manufactured in each exemplary embodiment may have a two-dimensional shape. However, here, the molded article having a two-dimensional shape means that the molded article has a thickness which depends on the diameter of the ejection port 65.

In addition, in each exemplary embodiment, it is described that the stand 20 is moved in the apparatus width direction, the apparatus depth direction, and the apparatus height direction, by the moving device 30. However, if the coating device 40 is configured to relatively move with respect to the stand 20, without moving the stand 20, the coating device 40 may be configured to be able to move. In addition, as the stand 20 is configured to be able to move in a part of a direction of the apparatus width direction and the apparatus depth direction, and the coating device 40 is configured to be able to move in a part of a direction of the apparatus height direction, the coating device 40 and the stand 20 may be configured to be able to relatively move.

In addition, it is described that the protrusion portions 66, 66A, and 66B and the unevenness portion 66C of the first exemplary embodiment and the first and the second modification examples of the first exemplary embodiment are formed in the end surface 64. However, if the protrusion portions 66, 66A, and 66B, and the unevenness portion 66C are in contact with the resin R and have a function of forming the line L, the protrusion portions 66, 66A and 66B, and the unevenness portion 66C may be provided as a different member on the end surface 64.

In addition, it is described that the protrusion portions 66 and 66A of the first exemplary embodiment and the first modification example of the first exemplary embodiment are members having a hemispherical shape. However, if the protrusion portions 66 and 66A are in contact with the resin R and have a function of forming the line L, the shape of the protrusion portions 66 and 66A may not be hemispherical.

In addition, it is described that the resin R which is used in each exemplary embodiment is the thermoplastic resin, and for example, is an acrylonitrile butadiene styrene resin. Here, the description that an example of the resin R is the acrylonitrile butadiene styrene resin means that the resin R itself or a main component (component which occupies most of a weight ratio) of the resin R is the acrylonitrile butadiene styrene resin. Therefore, for example, the resin R is the resin in which the main component is the acrylonitrile butadiene styrene resin, and may contain other components, such as a so-called colorant, including a pigment, a dye, or the like.

In addition, it is described that the resin R which is used in each exemplary embodiment is the acrylonitrile butadiene styrene resin. However, the resin R which is used in each exemplary embodiment may not be the acrylonitrile butadiene styrene resin, if the resin R is a PLA resin (polylactic resin), a PC resin (polycarbonate resin), a PEEK resin (polyether ether ketone resin), a PPSF resin (polyphenyl sulfone resin), or other thermoplastic resin. In addition, when these thermoplastic resins are used as the resin R instead of the acrylonitrile butadiene styrene resin, as described above, the resin R may contain other components.

In addition, it is described that the resin R which is used in each exemplary embodiment is the thermoplastic resin. However, in each exemplary embodiment, instead of the resin R, a photoreactive resin (resin which reacts to the light and is polymerized when irradiation with the light having a certain wavelength is performed) may be used. In this case, after forming the line in the ejected resin, as a configuration in which the photoreactive resin is irradiated with the light after coating by using a photoirradiation device (not illustrated), a configuration in which the photoreactive resin is hardened may be employed. Examples of the photoreactive resin include an epoxy acrylate resin or the like which reacts to an ultraviolet ray and is polymerized. In addition, as an example of the photoirradiation device, an ultraviolet ray irradiation device (not illustrated) may be used. In this case, the coating device 40 may not be provided with the heating portion 70.

In addition, it is described that the resin R which is used in each exemplary embodiment is the thermoplastic resin. However, in each exemplary embodiment, instead of the resin R, a thermosetting resin (a resin which polymerizes and hardens when being heated) may be used. In this case, after forming the line in the ejected resin, as a configuration in which the thermosetting resin is heated after coating by using a heating device (not illustrated), a configuration in which the thermosetting resin is hardened may be employed. Examples of the thermosetting resin include an epoxy resin or the like. In this case, the coating device 40 may not be provided with the heating portion 70.

In addition, in the first exemplary embodiment, it is described that the end surface 64 of the ejection portion 62 is in contact with the ejected resin R and is moved. However, if the forming apparatus 10 is configured so that the protrusion portion 66 is interfered with by the resin R and forms the line L in the resin R, the forming apparatus 10 may be configured so that the end surface 64 of the ejection portion 62 is not in contact with the resin R.

In addition, it is described that the forming apparatus of each exemplary embodiment selects the first mode and the second mode, and manufactures the molded article. However, a mode other than these modes may be notified to the operator and the forming apparatus may manufacture the molded article in the mode selected by the operator other than these modes.

In addition, it is described that the forming apparatus of each exemplary embodiment selects the first mode and the second mode, and manufactures the molded article. However, as the forming apparatus selects the route according to the result of calculating the route from the data of the molded article by the forming apparatus and a preset priority, the operator may not be notified and may not select the mode. For example, when there are plural routes, the forming apparatus may be configured to select the route which has the shortest manufacturing time as the preset priority.

In addition, it is described that the forming apparatus of each exemplary embodiment selects the first mode and the second mode, and manufactures the molded article. However, without calculating the route from the data of the molded article by the forming apparatus 10, the molded article may be manufactured by the route based on a preset method. For example, the forming apparatus 10 may be configured so that the molded article may be manufactured only in the first mode as the route based on the preset method. In this case, it is not required that the forming apparatus 10 allow the operator to select the mode based on the plural routes.

In addition, it is described that the forming apparatus of each exemplary embodiment selects the first mode and the second mode, and manufactures the molded article. However, the forming apparatus may be used as an apparatus which manufactures only the molded article which has a preset shape, that is, a dedicated machine for manufacturing the molded article having a preset shape. In this case, since it is not required that the forming apparatus calculate the route from the data of the molded article, it is not required to have a function of calculating the route and a function of notifying the mode to the operator.

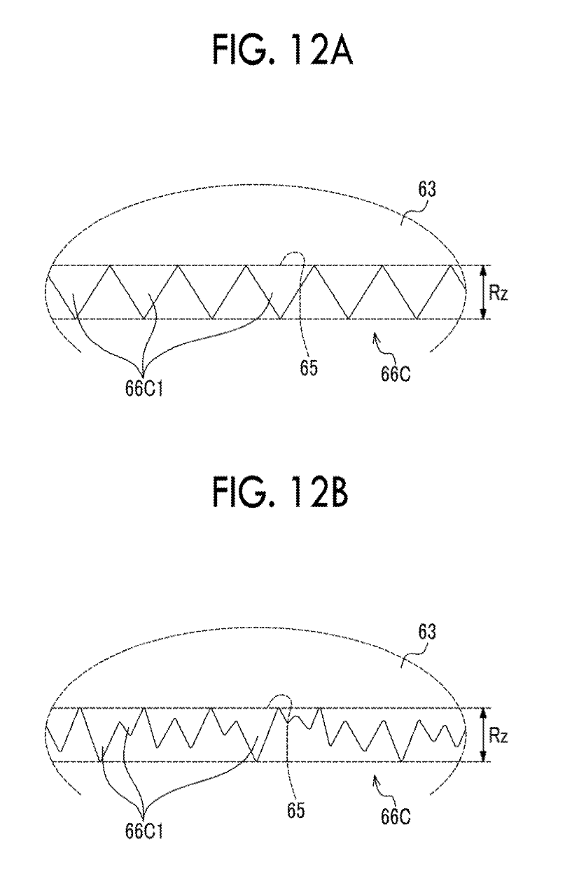

In addition, in the third modification example (refer to FIGS. 11A and 11B) of the first exemplary embodiment, the end surface 64 of the head 60C is described as a surface on which the unevenness portion 66C is formed, that is, the unevenness portion 66C. However, as illustrated in FIGS. 12A and 12B, a projected portion 66C1 which constitutes the unevenness portion 66C may be considered as an example of the protrusion portion which is more protruded in a direction in which the resin R is ejected from the ejection port 65 than the ejection port 65. In addition, the projected portion 66C1 may be considered as an example of the line forming portion. In addition, the projected portion 66C1 is formed to surround the ejection port 65. From a different point of view, plural projected portions which constitute the projected portion 66C1 are disposed to surround the ejection port 65.

In addition, in the exemplary embodiments other than the third modification example of the first exemplary embodiment, a shape when the ejection port is viewed from the lower side of the apparatus height direction is described as a circular shape. However, if a function of ejecting the resin R is provided, the shape of the ejection port may not be a circular shape.

In addition, in the third exemplary embodiment and the modification examples thereof, the end surface 64 of the heads 60F, 60G, and 60H is described to be in contact with the ejected resin R and be moved. However, when manufacturing the molded article by using the forming apparatus of the third exemplary embodiment and the modification examples thereof, the end surface 64 of the heads 60F, 60G, and 60H may be configured not to be in contact (be separated from) the ejected resin R and be moved. Even in this case, as the line L is formed in the resin R ejected from the ejection port 65 of the heads 60F, 60G, and 60H according to the ejection, the line L is formed in the resin R which is ejected from the ejection port 65 of the heads 60F, 60G, and 60H, and which coats the stand 20.

In addition, in the third exemplary embodiment and the first modification example, it is described that the three through holes 63A are formed in the head 60F, and the four through holes 63B are formed in the head 60G. However, in these exemplary embodiments, if the plural ejection ports 65 are formed in the end surface 64, each of the through holes 63A and 63B may not be formed in the head 60F and the head 60G. For example, in the head, since the through hole 63 of the head 60 of the first embodiment is formed, and in order to form the plural ejection ports in the end surface 64 of the head, the plate in which the plural through holes are formed may be fixed to the end surface 64.

In addition, in the first modification example of the third exemplary embodiment, it is described that, when the head 60G is relatively moved in a direction other than the preset direction with respect to the stand 20, the resins R ejected from each of the ejection ports 65B is overlapped two by two, but coating is performed with the resin R in a state where the resin R is divided into two. For this reason, it is described that, when manufacturing the molded article by using the head 60G, it is required that the head 60G be relatively moved in the preset direction with respect to the stand 20. However, according to a relationship, such as characteristics of viscosity or the like of the resin R, or a separation distance between the end surface 64 of the head 60G and the stand 20, the line L may be formed and coating may be performed in a state where the resin R is in contact with the stand 20 right after being ejected from each of the ejection ports 65B. In this case, an aspect in which the head 60G is relatively moved in the direction other than the preset direction with respect to the stand 20 is also in a range of the technical idea of the invention.

In addition, each exemplary embodiment is described as a separate individual exemplary embodiment. However, it goes without saying that an exemplary embodiment in which configurations of each exemplary embodiment are combined with each other is also included in the range of the technical idea of the invention. For example, a head, in which the unevenness portion 66C of the third modification example (refer to FIGS. 11A and 11B) of the first exemplary embodiment is the end surface 64 of the heads 60F, 60G, and 60H of the third exemplary embodiment and the modification examples thereof, may be employed. In addition, for example, the pipe portion 90 of the fourth modification example (refer to FIGS. 13A and 13B) of the first exemplary embodiment may be employed as a head which is disposed to cover the outer circumferential surface of the heads 60F, 60G, and 60H of the third exemplary embodiment and the modification examples thereof. In these cases, the line L which is formed according to the ejection, and the line L which is formed by the unevenness portion 66C and the projection 66D according to the relative movement of the head with respect to the stand 20, are affixed to the resin R ejected from the ejection port of the head. In other words, the heads in these cases form the line L in the resin R according to the ejection while being relatively moved with respect to the stand 20, that is, according to the relative movement and the ejection, the stand 20 is coated with the resin R. The heads in these cases may combine the heads 60F, 60G, and 60H of the third exemplary embodiment and the modification examples thereof by adjusting the number or the like, such as the roughness of the front surface of the unevenness portion 66C or the size of the projection 66D, so that the line J which depends on the diameter of the ejection port 65 is unlikely to stand out.

### Example

### Overview

Here, an experiment is performed by preparing a head of Example which will be described below and a head of a comparative example, and by replacing the above-described head 60 of the forming apparatus 10 of the first exemplary embodiment with the above-described head. In the experiment, the spatial frequency of the front surface of the molded article which is manufactured by using the two above-described heads is measured and compared.

### Experiment Method

As the head of Example, the above-described head of the comparative apparatus, that is, the head in which the end surface 64 of the ejection portion 62 is a plane is prepared, and an unevenness pitch which is smaller than the diameter of the ejection port 65 is formed by a file in the end surface 64. In contrast, the head of the comparative example is the above-described head of the comparative apparatus.

Then, the prepared head of Example and the head of the comparative example are attached instead of the head 60 of the forming apparatus 10, and the circular truncated cone M is manufactured in the same manner as in the first exemplary embodiment. In addition, the used resin R is similar to that in the first exemplary embodiment.

After manufacturing the circular truncated cone M by the forming apparatus 10 to which each head is attached, the shape of the upper surface of each circular truncated cone M is measured by using a probe type step profiler “NanoMap500LS” (not illustrated) manufactured by AEP Technology, and the spatial frequency is analyzed by using frequency analyzing software (SPIP) manufactured by AEP Technology.

Evaluation Result

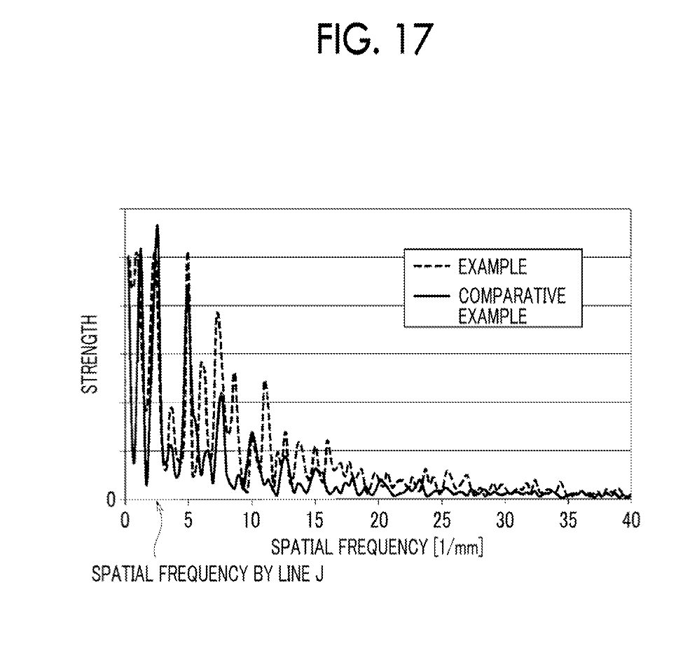

The result of the above-described spatial frequency analysis is as illustrated in FIG. 17. If FIG. 17 is simply described, a value on a horizontal axis is the spatial frequency (i/mm), and a value on a vertical axis is strength thereof. Values on the vertical axis in Example and the comparative example respectively illustrate values normalized by their respective zeroth-order components.

The circular truncated cone M manufactured by using the head of the comparative example has higher strength by the line J compared to the zero-order component (smooth part). Meanwhile, a strength difference by the line J between the circular truncated cone M manufactured by using the head of Example and the zero-order component (smooth part) is small (hereinafter, referred to as an evaluation result 1). Furthermore, circular truncated cone M manufactured by using the head of Example shows an increased high frequency component by the line J, compared to the circular truncated cone M manufactured by using the head of the comparative example (hereinafter, referred to as an evaluation result 2).

Consideration

When coating is performed with the resin R by using the head of Example, as the unevenness pitch formed in the end surface 64 of the head of Example is in contact with a part in the periphery of the line J in the resin R, it is assumed that the evaluation result 1 is obtained because the line L is formed at a part in the periphery of the line J.

In addition, when coating is performed with the resin R by using the head of Example, as the unevenness pitch is formed in the end surface 64 of the head of Example, it is assumed that the evaluation result 2 is obtained because the unevenness pitch is in contact with the entire front surface of the resin R, and the line L is formed on the entire front surface of the molded article.

Then, because of the two above-described results, it is assumed that the circular truncated cone M manufactured by using the head of Example is unlikely to cause the line J to stand out, compared to the circular truncated cone M manufactured by using the head of the comparative example.

It is assumed that the head of Example performs similar operations as those in cases of the heads 60, and 60A to 60C of the first exemplary embodiment and the modification examples thereof.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A forming apparatus, comprising:
a stand; and
a coating portion that is relatively moved with respect to the stand while ejecting a resin to coat the stand with the resin, and forms a line in the resin according to at least one of the ejection and the movement, in order to manufacture a molded article by the resin on the stand.

2. The forming apparatus according to claim 1,
wherein the coating portion includes:
an ejection portion in which the ejection port which ejects the resin with respect to the stand is formed; and
a line forming portion that is further protruded than the ejection port in a direction in which the resin is ejected from the ejection port, and is in contact with the resin ejected from the ejection port according to the movement and forms the line in the resin.

3. The forming apparatus according to claim 1,
wherein the coating portion includes:
an ejection portion in which the ejection port which ejects the resin with respect to the stand is formed on an end surface; and
a line forming portion that is an unevenness portion formed on the end surface, and is in contact with the resin ejected from the ejection port according to the movement and forms the line in the resin.

4. The forming apparatus according to claim 2, further comprising:
a moving portion that relatively moves the coating portion in a plurality of directions along the stand, with respect to the stand,
wherein a plurality of line forming portions are disposed to surround the ejection port.

5. A manufacturing method of a molded article, the method comprising:
with using the forming apparatus according to claim 1, in manufacturing the molded article by a resin on the stand,
coating the stand with the resin by a relative movement with respect to the stand while ejecting the resin; and
forming the line in the resin according to the ejection or the movement.

6. A coating portion used in the forming apparatus according to claim 1, comprising:
an ejection portion in which an ejection port which ejects a resin is formed; and
a plurality of protrusion portions that are disposed to surround the ejection port and that are further protruded than the ejection port in a direction in which the resin is ejected from the ejection port.
